(19) United States
(12) Patent Application Publication
(10) Pub. No.: US 2024/0386885 A1
(43) Pub. Date: Nov. 21, 2024

(54) LANGUAGE MODELS USING SPOKEN LANGUAGE MODELING

(71) Applicant: Google LLC, Mountain View, CA (US)

(72) Inventors: Michelle Dana Tadmor, Mountain View, CA (US); Eliya Nachmani, Tel Aviv (IL); Alon Levkovitch, Givatayim (IL); Julian Salazar, San Francisco, CA (US); Chulayuth Asawaroengchai, Zurich (CH); Russell John Wyatt Skerry-Ryan, Mountain View, CA (US); Soroosh Mariooryad, Redwood City, CA (US)

(73) Assignee: Google LLC, Mountain View, CA (US)

(21) Appl. No.: 18/662,442

(22) Filed: May 13, 2024

Related U.S. Application Data
(60) Provisional application No. 63/502,901, filed on May 17, 2023.

(51) Int. Cl. G10L 15/183; G10L 13/027; G10L 15/02; G10L 15/06; G10L 25/18

(52) U.S. Cl. CPC G10L 15/183; G10L 13/027; G10L 15/02; G10L 15/063; G10L 25/18

(57) ABSTRACT

A method includes receiving an input sequence of speech features characterizing a spoken prompt. The method also includes generating a corresponding sequence of audio encodings using an audio encoder of a spoken language model. Without applying any intermediary cross-attention to the sequence of audio encoding between the audio encoder and a language model decoder of the spoken language model, the method includes processing the sequence of audio encodings generated by the audio encoder using the language model decoder to generate an output sequence of speech features characterizing a continuation of the spoken prompt.

### CROSS REFERENCE TO RELATED APPLICATIONS

This U.S. Patent Application claims priority under 35 U.S.C. § 119 (e) to U.S. Provisional Application 63/502,901, filed on May 17, 2023. The disclosure of this prior application is considered part of the disclosure of this application and is hereby incorporated by reference in its entirety.

### TECHNICAL FIELD

This disclosure relates to language models using spoken language modeling.

### BACKGROUND

Natural language processing (NLP) aims to develop computational models that can understand and generate human language. By capturing statistical patterns and structures of text-based natural language, language models can predict and generate coherent and meaningful sequences of words. Combined with a Transformer model architecture, large language models (LLMs) trained on web-scale amounts of text, with proportionate compute size, have demonstrated remarkable success in NLP tasks. However, transferring these abilities to spoken human language, in contrast to text-based natural language, remains a challenging problem. That is, spoken dialog systems include a cascade of separately trained models including automatic speech recognition (ASR), natural language understanding (NLU), natural language generation (NLG), and text-to-speech (TTS). Consequently, the cascade of these models introduces significant latency when operating the spoken dialog systems.

### SUMMARY

One aspect of the disclosure provides a spoken language model that includes an audio encoder and a language model decoder. The audio encoder is configured to receive, as input, a sequence of speech features characterizing a spoken prompt and generate, as output, a corresponding sequence of audio encodings. The language model decoder is configured to receive, as input, the sequence of audio encodings output from the audio encoder without any intermediary cross-attention applied to the sequence of audio encodings between the audio encoder and the language model decoder and generate, as output, an output sequence of speech features characterizing a continuation of the spoken prompt.

Implementations of the disclosure may include one or more of the following optional features. In some implementations, the language model decoder is further configured to generate, as output, a transcription of the spoken prompt and a text representation of the continuation. Here, the language model decoder may generate the output sequence of speech features autoregressively based on a concatenation of the transcription of the spoken prompt and the text representation of the continuation. In these implementations, the language model decoder may generate the output sequence of speech features autoregressively based on generating each speech feature in the output sequence of speech features at each corresponding time step subsequent to an initial time step by: obtaining the speech feature generated by the language model decoder at an immediately previous time step; processing, by an input acoustic projection layer, the speech feature generated by the language model decoder at the immediately previous time step to generate a corresponding previous input speech embedding; processing, using the language model decoder, the sequence of audio encodings, the concatenation of the transcription of the spoken prompt and the text representation of the continuation, and the corresponding previous input speech embedding to generate a corresponding output speech embedding at the corresponding time step; and processing, by an output acoustic projection layer, the corresponding output speech embedding to generate the speech feature at the corresponding time step.

In some examples, the output sequence of speech features includes a sequence of output speech embeddings in a domain of the language model decoder and the spoken language model further includes an output acoustic projection layer configured to project the sequence of output speech embeddings into an output sequence of mel-spectrograms frames characterizing the continuation of the spoken prompt. In these examples, a synthesizer may be configured to convert the output sequence of mel-spectrogram frames into synthesized speech that conveys the continuation of the spoken prompt and an audible output device is configured to audibly output the synthesized speech conveying the continuation of the spoken prompt.

The sequence of speech features may include an input sequence of mel-frequency spectrogram frames. In some implementations, the audio encoder includes a plurality of multi-head attention layers. In these implementations, each multi-head attention layer includes a conformer layer including a first feed-forward layer, a self-attention layer, a convolution layer, and a second feed-forward layer. The language model decoder may include a prefix-language model architecture.

In some examples, a training process jointly trains the audio encoder and the language model decoder by: obtaining a plurality of training utterances, each respective training utterance including audio data segmented into a first sequence of reference speech features characterizing a corresponding prompt segment of the respective training utterance and a second sequence of reference speech features characterizing a corresponding continuation segment of the respective training utterance, and a ground-truth transcript of the audio data segmented into a first text segment representing a transcription of the corresponding prompt segment of the respective training utterance and a second text segment representing a transcription of the corresponding continuation segment of the training utterance; for each respective training utterance, processing, by the audio encoder, the first sequence of reference speech features to generate a corresponding sequence of training audio encodings, processing, by the language model decoder, the corresponding sequence of training audio encodings to generate a corresponding predicted sequence of speech recognition results and the first text segment to generate a corresponding predicted text segment, determining a first cross-entropy loss term based on the corresponding predicted sequence of speech recognition results and the first text segment representing the transcription of the corresponding prompt segment of the respective training utterance, and determining a second cross-entropy loss term based on the corresponding predicted text segment and the second text segment representing the transcription of the corresponding continuation segment of the respective training utterance; and training the spoken language model based on the first cross-entropy loss terms and the second cross-entropy loss terms determined for the plurality of training utterances. In these examples, the training process further trains the audio encoder and the language model decoder by, for each respective training utterance: processing, by an input acoustic projection layer, the second sequence of reference speech features to generate a corresponding sequence of reference speech embeddings; processing, by the language model decoder, the corresponding sequence of reference speech embeddings to generate a corresponding sequence of predicted speech embeddings; processing, by an output acoustic projection layer, the corresponding sequence of predicted speech embeddings to generate a corresponding sequence of predicted speech features; and determining a speech reconstruction loss based on the corresponding sequence of predicted speech features and the corresponding second sequence of reference speech features characterizing the continuation segment of the training utterance, and training the spoken language model based on the first cross-entropy loss terms, the second cross-entropy loss terms, and the reconstruction losses determined for the plurality of training utterances.

Determining the reconstruction loss may include determining first and second reconstruction loss terms between the corresponding sequence of predicted speech features and the second corresponding sequence of reference speech features, determining feature-deltas between the corresponding sequence of predicted speech features and the corresponding second sequence of reference speech features, determining time-deltas between the corresponding sequence of predicted speech features and the corresponding second sequence of reference speech features, and determining the speech reconstruction loss based on a function of the first and second reconstruction loss terms, the feature-deltas, and the time deltas. In some implementations, prior to jointly training the audio encoder and the language model decoder, the audio encoder is initialized with a pre-trained audio encoder and the language model decoder is initialized with a pre-trained language model decoder.

Another aspect of the disclosure provides a computer-implemented method that when executed on data processing hardware causes the data processing hardware to perform operations for executing a spoken language model. The operations include receiving an input sequence of speech features characterizing a spoken prompt. The operations also include generating a corresponding sequence of audio encodings using an audio encoder of a spoken language model. Without applying any intermediary cross-attention to the sequence of audio encodings between the audio encoder and a language model decoder of the spoken language model, the operations include processing the sequence of audio encodings generate by the audio encoder using the language model decoder to generate an output sequence of speech features characterizing a continuation of the spoken prompt.

Implementations of the disclosure may include one or more of the following optional features. In some implementations, the operations further include generating, using the language model decoder, a transcription of the spoken prompt and a text representation of the continuation. Here, the language model decoder may generate the output sequence of speech features autoregressively based on a concatenation of the transcription of the spoken prompt and the text representation of the continuation. In these implementations, the language model decoder generates the output sequence of speech features autoregressively based on generating each speech feature in the output sequence of speech features at each corresponding time step subsequent to an initial time step by: obtaining the speech feature generated by the language model decoder at an immediately previous time step; processing, by an input acoustic projection layer, the speech feature generated by the language model decoder at the immediately previous time step to generate a corresponding previous input speech embedding; processing, using the language model decoder, the sequence of audio encodings, the concatenation of the transcription of the spoken prompt and the text representation of the continuation, and the corresponding previous input speech embedding to generate a corresponding output speech embedding at the corresponding time step; and processing, by an output acoustic projection layer, the corresponding output speech embedding to generate the speech feature at the corresponding time step.

In some examples, the output sequence of speech features includes a sequence of output speech embedding in a domain of the language model decoder and the operations further include projecting, using an output acoustic projection layer of the spoken language model, the sequence of output speech embedding into an output sequence of mel-spectrogram frames characterizing the continuation of the spoken prompt. In these examples, the operations may further include converting, using a synthesizer, the output sequence of mel-spectrogram frames into synthesized speech that conveys the continuation of the spoken prompt and audibly outputting, using an audible output device, the synthesized speech conveying the continuation of the spoken prompt.

The sequence of speech features may include an input sequence of mel-frequency spectrogram frames. In some implementations, the audio encoder includes a plurality of multi-head attention layers. In these examples, each multi-head attention layer may include a conformer layer including a first feed-forward layer, a self-attention layer, a convolution layer, and a second feed-forward layer. The language model decoder may include a prefix-language model architecture.

In some examples, the operations further include executing a training process that jointly trains the audio encoder and the language model decoder by: obtaining a plurality of training utterances, each respective training utterance including audio data segmented into a first sequence of reference speech features characterizing a corresponding prompt segment of the respective training utterance and a second sequence of reference speech features characterizing a corresponding continuation segment of the respective training utterance, and a ground-truth transcript of the audio data segmented into a first text segment representing a transcription of the corresponding prompt segment of the respective training utterance and a second text segment representing a transcription of the corresponding continuation segment of the training utterance; for each respective training utterance, processing, by the audio encoder, the first sequence of reference speech features to generate a corresponding sequence of training audio encodings, processing, by the language model decoder, the corresponding sequence of training audio encodings to generate a corresponding predicted sequence of speech recognition results and the first text segment to generate a corresponding predicted text segment, determining a first cross-entropy loss term based on the corresponding predicted sequence of speech recognition results and the first text segment representing the transcription of the corresponding prompt segment of the respective training utterance, and determining a second cross-entropy loss term based on the corresponding predicted text segment and the second text segment representing the transcription of the corresponding continuation segment of the respective training utterance; and training the spoken language model based on the first cross-entropy loss terms and the second cross-entropy loss terms determined for the plurality of training utterances. In these examples, the training process further trains the audio encoder and the language model decoder by, for each respective training utterance: processing, by an input acoustic projection layer, the second sequence of reference speech features to generate a corresponding sequence of reference speech embeddings; processing, by the language model decoder, the corresponding sequence of reference speech embeddings to generate a corresponding sequence of predicted speech embeddings; processing, by an output acoustic projection layer, the corresponding sequence of predicted speech embeddings to generate a corresponding sequence of predicted speech features; and determining a speech reconstruction loss based on the corresponding sequence of predicted speech features and the corresponding second sequence of reference speech features characterizing the continuation segment of the training utterance, and training the spoken language model based on the first cross-entropy loss terms, the second cross-entropy loss terms, and the reconstruction losses determined for the plurality of training utterances.

Determining the reconstruction loss may include determining first and second reconstruction loss terms between the corresponding sequence of predicted speech features and the corresponding second sequence of reference speech features, determining feature-deltas between the corresponding sequence of predicted speech features and the corresponding second sequence of reference speech features, determining time-deltas between the corresponding sequence of predicted speech features and the corresponding second sequence of reference speech features, and determining the speech reconstruction loss based on a function of the first and second reconstruction loss terms, the feature-deltas, and the time deltas. In some implementations, prior to jointly training the audio encoder and the language model decoder, the operations further include initializing the audio encoder with a pre-trained audio encoder and initializing the language model decoder with a pre-trained language model decoder.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a system executing a spoken language model.

FIG. 2 is a schematic view of an example multi-head attention layer corresponding to a conformer layer.

FIG. 3 is a schematic view of an example training process training the spoken language model of FIG. 1.

FIG. 4 is a flowchart of an example arrangement of operations for a computer-implemented method of executing the spoken language model.

FIG. 5 is a schematic view of an example computing device that may be used to implement the systems and methods described herein.

Like reference symbols in the various drawings indicate like elements.

### DETAILED DESCRIPTION

Large language models (LLMs) have become more popular in recent years. A number of recent studies have explored the use of LLMs for spoken language understanding and fine-tuning the LLMs on audio data to perform speech-to-text question answering tasks. These models were able to answer text questions in response to input audio in a direct manner. However, fine-tuning LLMs for particular speech-related tasks, such as question answering, requires a significant amount of time and computational resources.

Implementations herein are directed towards a spoken language model and a method of executing the spoken language model. The spoken language model includes an audio encoder and a language model decoder. The audio encoder is configured to receive, as input, a sequence of speech features characterizing a spoken prompt and generate, as output, a corresponding sequence of audio encodings. The language model decoder is configured to receive, as input, the sequence of audio encodings output from the audio encoder without any intermediary cross-attention applied to the sequence of audio encodings between the audio encoder and the language model decoder and generate, as output, an output sequence of speech features characterizing a continuation of the spoken prompt.

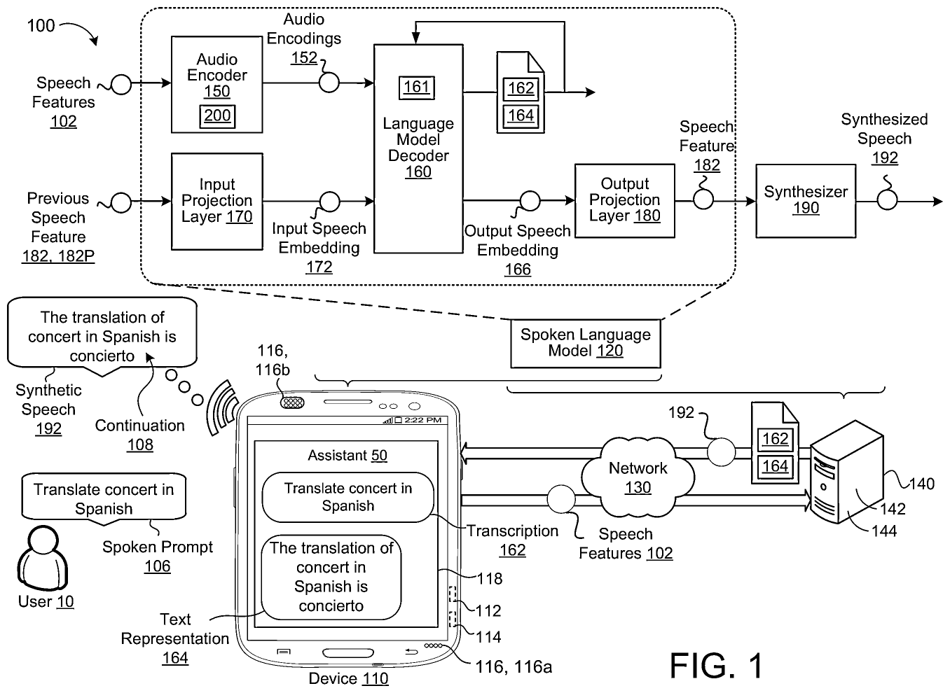

FIG. 1 illustrates an example system 100 whereby a user 10 may interact with a computing device, such as a user device 110, through voice input. Alternatively, the user 10 may interact with the user device 110 through textual inputs (e.g., via a keyboard or touch interface). The user device 110 (also referred to generally as a device 110) is configured to capture sounds (e.g., streaming audio data) from one or more users 10. Here, the streaming audio data may refer to an utterance 106 spoken by the user 10 that functions as an audible prompt/query, a command for the user device 110, or an audible communication captured by the user device 110. Speech-enabled systems of the user device 110 may field the query or command by answering the query and/or causing the command to be performed/fulfilled by one or more downstream applications. For instance, in the example shown, the user 10 interacts with a digital assistant 50 of the user device 110 that uses a spoken language model 120. The digital assistant 50 displays a digital assistant interface 118 on a screen of the user device 110 to depict a conversation between the user 10 and the digital assistant 50.

The user device 110 may correspond to any computing device associated with the user 10 and capable of receiving audio data. Some examples of user devices 110 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. The user device 110 includes data processing hardware 112 and memory hardware 114 in communication with the data processing hardware 112 and stores instructions, that when executed by the data processing hardware 112, cause the data processing hardware 112 to perform one or more operations. The user device 110 further includes an audio system 116 with an audio capture device (e.g., microphone) 116, 116a for capturing and converting the utterances 106 spoken by the user 10 into electrical signals and a speech output device (e.g., speaker) 116, 116b for communicating an audible audio signal (e.g., as output audio data from the user device 110). That is, the audio capture device 116a may convert the utterances 106 spoken by the user 10 into a sequence of speech features 102. While the user device 110 implements a single audio capture device 116a in the example shown, the user device 110 may implement an array of audio capture devices 116a without departing from the scope of the present disclosure, whereby one or more capture devices 116a in the array may not physically reside on the user device 110, but be in communication with the audio system 116.

The user device 110 communicates with a remote system 140 via a network 130. The remote system 140 may be a distributed system (e.g., cloud computing environment) having scalable elastic resources. The resources include computing resources (e.g., data processing hardware) 142 and/or storage resources (e.g., memory hardware) 144. Additionally or alternatively, the remote system 104 may be a centralized system. The network 130 may be wired, wireless, or a combination thereof, and may include private networks and/or public networks, such as the Internet.

The spoken language model 120 may execute on the user device 110, the remote system 140, or some combination thereof. The spoken language model 120 is configured to receive a respective utterance 106 spoken by the user 10 and generate an output sequence of speech features 182 characterizing the continuation 108 of the respective utterance 106. In some examples, the utterances 106 spoken by the user 10 correspond to spoken prompts. As such, utterances 106 may be interchangeably referred to as “spoken prompts 106” herein. Spoken prompts 106 may include any query, command, or other audible communication captured by the user device 110 (e.g., any command or query spoken by the user 10). In some examples, the user 10 may input textual prompts via a touch interface or a keyboard of the user device 110 in lieu of speaking the spoken prompt 106. The continuation 108 generated by the spoken language model 120 represents a response to the spoken prompt 106.

For example, the spoken prompt 106 may be a question spoken by the user 10 whereby the spoken language model 120 generates a corresponding continuation 108 that answers the question. In another example, the spoken prompt 106 may be a request to summarize information from a document or a collection of documents such that the spoken language model generates a corresponding continuation 108 that summarizes the document or the collection of documents. In another example, the spoken prompt 106 may be a request to translate speech or text in a first language to a different second language whereby the spoken language model 120 translates the speech or text to the different second language. In yet another example, the spoken prompt 106 may be a partial phrase or sentence that the spoken language model 120 generates a corresponding continuation 108 for that completes the partial phrase or sentence. For instance, the user 10 may speak the partial phrase of “I have scheduled this” as the spoken prompt 106 whereby the spoken language model 120 generates the continuation 108 of “meeting” as the most likely next term in the phrase.

The spoken language model 120 may include an audio encoder 150, a language model decoder 160, an input acoustic projection layer 170, an output acoustic projection layer 180, and/or a synthesizer 190. The synthesizer 190 may be integrated with the spoken language model 120 or may include a distinct component from the spoken language model 120. The audio encoder 150 is configured to receive, as input, the sequence of speech features 102 characterizing the spoken prompt 106 and generate, as output, a corresponding sequence of audio encodings 152. The sequence of speech features 102 may include an input sequence of mel-frequency spectrogram frames. The audio encoder 150 may include a pre-trained audio encoder from a pre-trained automatic speech recognition (ASR) model. In some examples, the audio encoder 150 operates in a streaming manner. That is, for each respective speech feature 102 in the sequence of speech features 102, the audio encoder 150 generates a corresponding audio encoding 152 and transmits the corresponding audio encoding 152 to the language model decoder 160. As such, at each time step (e.g., output step) of a plurality of time steps, the audio encoder 150 generates a corresponding audio encoding 152. The audio encoder 150 may additionally or alternatively operate in a non-streaming mode and process look-ahead or right context audio features 102 when generating an audio encoding 152 for a corresponding audio feature 102. In some implementations, the audio encoder 150 includes a cascaded audio encoder that includes a causal encoder and a non-causal encoder stacked on top of the causal encoder.

The spoken language model 120 may include a projection layer (Ps) disposed between the audio encoder 150 and the language model decoder 160. Here, the projection layer (not shown) is configured to project the sequence of audio encodings 152 into an embedding dimension of the language model decoder 160 represented by:

$${x}_{p}^{l m} = {P}_{s} ( ε ( {x}_{p} ) ) \qquad ( 1 )$$

The audio encoder 150 may include a plurality of multi-head attention layers 200. In some configurations, each multi-head attention layer 200 from the plurality of multi-head attention layers 200 includes a conformer layer. In other configurations, the multi-head attention layers 200 correspond to transformer or performer layers.

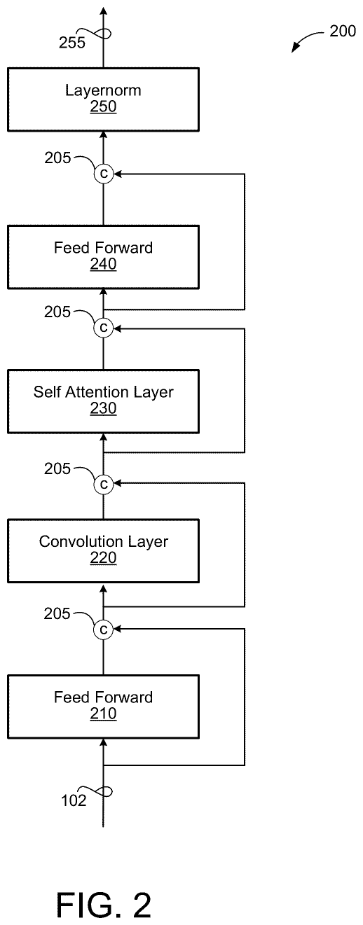

FIG. 2 illustrates an example multi-head attention layer 200 corresponding to a conformer layer. The conformer layer may include a first half feed-forward layer 210, a second half feed-forward layer 240, with a convolution layer 220 and a multi-head self-attention layer disposed between the first and second half feed-forward layers 210, 240, and concatenation operators 205. Optionally, the conformer layer may include a layernorm module 250. The first half feed-forward layer 210 processes the sequence of speech features 102 by projecting the speech features 102 into a larger dimension, followed by a non-linear activation, and then another linear layer to project the features back to the original dimensions. Subsequently, the convolution layer 220 subsamples the sequence of sequence of speech features 102 concatenated with the output of the first half feed-forward layer 210. That is, the convolution layer 220 aggregates information from neighboring context to capture relative offset-based local interactions. The multi-head self-attention layer 230 may include a stack of self-attention layers, such as conformer or transformer layers. The multi-head self-attention layer 230 receives the output of the convolution layer 220 concatenated with the output of the first half feed-forward layer 210. Intuitively, the role of the multi-head self-attention layer 230 is to summarize noise context separately for each input frame that is to be enhanced. The multi-head self-attention layer 230 looks back L previous frames and converts and output into a fixed-length vector thereby capturing more global patterns. The multi-head self-attention layer 230 maintains a large number of internal states. A significant portion of these internal states correspond to the key and value tensors of self-attention causing an increase in latency due to repeatedly loading each of these internal states (e.g., quadratic computational cost).

Thereafter, the second half feed-forward layer 240 receives a concatenation of the output of the multi-head self-attention layer 230 and the output of the convolution layer 220. The layernorm module 250 processes a concatenation of the output from the second half feed-forward layer 240 and the output of the multi-head self-attention layer 230. That is, the conformer layer transforms each speech feature 102 in the sequence of speech features 102 (e.g., input features x), using modulation features m, to generate, at each output step, an output 255 for a corresponding speech feature 102 in the sequence of speech features 102. More specifically, the conformer layer may generate the output 255 according to:

$$\hat{x} = x + r ( m ) ⊙ x + h ( m ) \qquad ( 2 )$$

$$\tilde{x} = \hat{x} + \frac{1}{2} F F N ( \hat{x} ) , \tilde{n} = n + \frac{1}{2} F F N ( n )$$

$${x}^{′} = \tilde{x} + C o n v ( \tilde{x} ) , {n}^{′} = \tilde{n} + Conv ( \tilde{n} )$$

$${x}^{″} = {x}^{′} + MHCA ( {x}^{′} , {n}^{′} )$$

$${x}^{′′′} = {x}^{′} ⊙ r ( {x}^{′′} ) + h ( {x}^{′′} )$$

$${x}^{″′′} = {x}^{′} + MHCA ( {x}^{′} , {x}^{′′′} )$$

$$y = LayerNorm ( {x}^{′′′′} + \frac{1}{2} FFN ( {x}^{″′′} ) )$$

The output 255 of each conformer layer of the plurality of conformer layers is transmitted to the next conformer layer of the plurality of conformer layers. A last conformer layer generates a corresponding audio encoding 152 for each respective speech feature 102 in the sequence of speech features 102.

Referring back to FIG. 1, the language model decoder 160 is configured to receive, as input, the sequence of audio encodings 152 output from the audio encoder 150 and generate, as output, a transcription 162 of the spoken prompt 106 and a text representation 164 of the continuation. The language model decoder 160 may include a pre-trained large language model (LLM). In some examples, the language model decoder 160 uses Retrieval-Augmented Generation (RAG) which is the process of optimizing the output of the language model decoder 160 by referencing authoritative data sources distinct from the training data before generating responses. The language model decoder 160 may include a prefix-language model architecture. Notably, the language model decoder 160 receives the sequence of audio encodings 152 without any intermediary cross-attention applied to the sequence of audio encodings 152 between the audio encoder 150 and the language model decoder 160.

The language model decoder 160 is further configured to generate, as output, an output sequence of speech features 182 characterizing the continuation of the spoken prompt 106. More specifically, the language model decoder 160 may obtain a concatenation 161 of the transcription 162 of the spoken prompt 106 and the text representation 164 of the continuation generated by the language model decoder 160 and generate the output sequence of speech features 182 autoregressively based on the concatenation 161. Thus, the language model decoder 160 may generate a corresponding speech feature 182 from the output sequence of speech features 182 at each respective time step of the plurality of time steps. In some examples, the language model decoder 160 pads the concatenation 161 with a start of sentence (SOS) token at the beginning of the concatenation 161 and an end of sentence (EOS) token at the end of the concatenation 161.

The spoken language model 120 may generate the output sequence of speech features 182 using the input acoustic projection layer 170, the language model decoder 160, and/or the output acoustic projection layer 180. In some examples, the input acoustic projection layer 170 and the output acoustic projection layer 180 are integrated with the language model decoder 160 such that the input to the input acoustic projection layer 170 serves as an input to the language model decoder 160 and the output of the output acoustic projection layer 180 serves as an output of the language model decoder 160. In other examples, the input acoustic projection layer 170 and the output acoustic projection layer 180 are separate components from the language model decoder 160. The language model decoder 160 generates the output sequence of speech

features 182 autoregressively based on generating each speech feature 182 in the output sequence of speech features 182 at each corresponding time step subsequent to an initial time step, by obtaining, via the input acoustic projection layer 170, the speech feature 182 from the output sequence of speech features 182 generated by the language model decoder 160 at an immediately previous time step (e.g., a previous speech feature 182, 182P). The input acoustic projection layer 170 processes the previous speech feature 182P to generate a corresponding previous input speech embedding 172. The input acoustic projection layer 170 may be a multi-layer perceptron that compresses the previous speech feature 182P into a lower dimension thereby creating a bottleneck that aids the decoding process for the language model decoder 160. This bottleneck mechanism prevents the language model decoder 160 from repetitively generating the same prediction in the decoding process. Thus, the language model decoder 160 processes the sequence of audio encodings 152, the concatenation 161 of the transcription 162 of the spoken prompt 106 and the text representation 164 of the continuation 108, and/or the corresponding previous input speech embedding 172 to generate a corresponding output speech embedding 166 at the corresponding time step. On the other hand, at the initial time step, the language model decoder 160 processes the sequence of audio encodings 152 and/or the concatenation 161 of the transcription 162 of the spoken prompt 106 and the text representation 164 of the continuation 108 to generate a corresponding output speech embedding 166 at the initial time step since no previous speech features 182 are available. Thereafter, the output acoustic projection layer 180 processes the corresponding output speech embedding 166 to generate the speech feature 182 at the corresponding time step. The output acoustic projecting layer 180 may also be a multi-layer perceptron that projects the output speech embedding 166 from the language model dimension to the spectrogram dimension.

In some implementations, the sequence of output speech embeddings 166 are in a domain of the language model decoder 160. Here, the output acoustic projection layer 180 is configured to project the sequence of output speech embeddings 166 into the sequence of output speech features 182 (e.g., output sequence of mel-spectrogram frames 182) characterizing the continuation 108 of the spoken prompt 106. Moreover, the synthesizer 190 is configured to convert the output sequence of mel-spectrogram frames 182 into synthesized speech 192 that conveys the continuation 108 of the spoken prompt 106. Specifically, the output sequence of mel-spectrogram frames 182 are in the frequency domain and the synthesizer 190 converts the mel-spectrogram frames 182 in the frequency domain into the synthesized speech 192 as a time-domain audio waveform. In some examples, the synthesizer 190 is a separate component from the spoken language model 120. In other examples, the synthesizer 190 is integrated with the spoken language model 120 (not shown). The spoken language model 120 transmits the synthesized speech 192 to the user device 110 which is configured to audibly output (e.g., via the speaker 116b) the synthesized speech 192 conveying the continuation of the spoken prompt 106. The synthesizer 190 is non-limiting and may include a parametric vocoder, a neural vocoder, or a streaming vocoder implementing a streaming Griffin-Lim algorithm.

In the example shown, the user 10 speaks the spoken prompt 106 of “translate concert in Spanish” whereby the spoken language model 120 generates the transcription 162 of the spoken prompt 106 and the text representation 164 of “the translation of concert in Spanish is concierto” of the continuation 108. Continuing with the example shown, the spoken language model 120 generates the output sequence of speech features 182 and transmits the output sequence of speech features 182 to the synthesizer 190. The synthesizer 190 generates the synthetic speech 192 that conveys the continuation 108 of the spoken prompt 106 and transmits the synthetic speech 192 to the user device 110 for audible output from the user device 110. Moreover, the spoken language model 120 may transmit the transcription 162 and the text representation 164 to the user device 110 such that the user device 110 displays the transcription 162 and the text representation 164 for the user 10 via the digital assistant interface 118 of the user device 110.

Advantageously, by having the same architecture (e.g., the language model decoder 160) decode the intermediate text (e.g., the transcription 162 and the text representation 164), the spoken language model 120 benefits from the language model decoder 160 being pre-trained in the text domain to first generate the text representation 164 of the continuation 108, and then, synthesize the text representation 164 of the continuation 108 into synthetic speech 192. Moreover, the intermediate text serves as intermediate reasoning, enhancing the quality of the synthesized speech 192, analogous to improvements in text-based language models when using intermediate scratchpads or chain-of-thought.

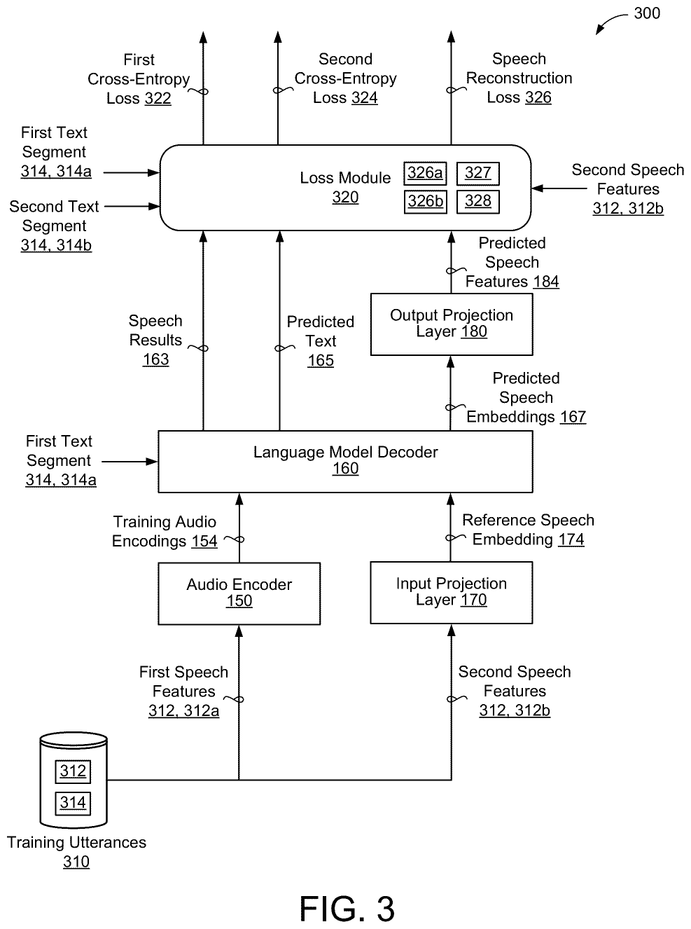

FIG. 3 illustrates an example training process 300 for training the spoken language model 120 (FIG. 1). In some implementations, the training process 300 jointly trains only the audio encoder 150 and the language model decoder 160 of the spoken language model 120. In other implementations, the training process 300 jointly trains other components of the spoken language model 120 in addition to, or in lieu of, jointly training the audio encoder 150 and the language model decoder 160, such as the input acoustic projection layer 170 and the output acoustic projection layer 180. Prior to jointly training the audio encoder 150 and the language model decoder 160, the training process 300 initializes the audio encoder 150 with a pre-trained audio encoder and initializes the language model decoder 160 with a pre-trained language model decoder.

The training process 300 obtains a plurality of training utterances 310 to train the spoken language model 120. Each respective training utterance 310 includes audio data 312 paired with a corresponding ground-truth transcript 314 of the audio data 312. The audio data 312 is segmented into a first sequence of reference speech features 312, 312a characterizing a corresponding prompt segment of the respective training utterance 310 and a second sequence of reference speech features 312, 312b characterizing a corresponding continuation segment of the respective training utterance 310. That is, the prompt segment of the respective training utterance 310 corresponds to a spoken prompt 106 spoken by the user 10 (FIG. 1) while the continuation segment of the respective training utterance corresponds to a ground-truth continuation 108 for the continuation segment. The ground-truth transcript 314 of the audio data 312 is segmented into a first text segment 314, 314a representing a transcription of the corresponding prompt segment of the respective training utterance 310 and a second text segment 314, 314b representing a transcription of the corresponding continuation segment of the respective training utterance 310. For instance, the audio data 312 for an example training utterance 310 of “how tall is Barrack Obama six foot two” is segmented into the first sequence of reference speech features 312a characterizing “how tall is Barrack Obama” and the second sequence of reference speech features 312b characterizing “six foot two.” Similarly, the ground-truth transcript 314 for the example training utterance 310 of “how tall is Barrack Obama six foot two” is segmented into the first text segment 314a representing a transcription of “how tall is Barrack Obama” and the second text segment 314b representing a transcription of “six foot two.”

For each respective training utterance 310, the audio encoder 150 processes the first sequence of reference speech features 312a of the respective training utterance 310 to generate a corresponding sequence of training audio encodings 154. The audio encoder 150 generates the sequence of training audio encodings 154 in a similar manner to generating the sequence of audio encodings 152 (FIG. 1). That is, for each respective training utterance 310, the language model decoder 160 processes the corresponding sequence of training audio encodings 154 to generate a corresponding predicted sequence of speech recognition results 163 and processes the first text segment 314a to generate a corresponding predicted text segment 165. That is, the language model decoder 160 processes the corresponding sequence of training audio encodings 154 to generate the corresponding predicted sequence of speech recognition results 163 that transcribe the prompt segment of the respective training utterance 310. Moreover, the language model decoder processes the second text segment 314b, which corresponds to the actual transcription of the prompt segment of the respective training utterance 310, to generate the predicted text segments 165 that predicts a textual representation of the continuation segment of the respective training utterance 310.

The training process 300 employs a loss module 320 that determines a first cross-entropy loss term 322 based on the corresponding predicted sequence of speech recognition results 163 and the first text segment 314a representing the transcription of the corresponding prompt segment of the respective training utterance 310. Moreover, the loss module 320 determines a second cross-entropy loss term 324 based on the corresponding predicted text segment 165 representing the transcription of the corresponding continuation segment of the respective training utterance 310. As such, the training process 300 trains the spoken language model 120 (FIG. 1) based on the first cross-entropy loss terms 322 and the second cross-entropy loss terms 324 determined for the plurality of training utterance 310. Here, training the spoken language model 120 may include updating parameters of the spoken language model 120.

In some implementations, for each respective training utterance 310, the input acoustic projection layer 170, processes the second sequence of reference speech features 312b to generate a corresponding sequence of reference speech embeddings 174. Here, the language model decoder 160 processes the corresponding sequence of reference speech embeddings 174 to generate a corresponding sequence of predicted speech embeddings 167. The output acoustic projection layer 180 processes the corresponding sequence of predicted speech embeddings 167 to generate a corresponding sequence of predicted speech features 184. Thereafter, the loss module 320 determines a speech reconstruction loss 326 based on the corresponding sequence of predicted speech features 184 and the corresponding second sequence of reference speech features 312b characterizing the continuation segment of the respective training utterance 310. The loss module 320 may determine the speech reconstruction loss 326 according to:

$${ℒ}_{S} ( {x}_{c} , {\hat{x}}_{c} ) = {ℒ}_{1 + 2} ( {x}_{c} , {\hat{x}}_{c} ) \qquad ( 3 )$$

$${ℒ}_{f} ( {x}_{c} , {\hat{x}}_{c} ) = {ℒ}_{1 + 2} ( {Δ}_{1}^{feat} ( {x}_{c} ) , {Δ}_{1}^{feat} ( {\hat{x}}_{c} ) )$$

$${ℒ}_{t} ( {x}_{c} , {\hat{x}}_{c} ) = {Σ}_{k = 1}^{K} {ℒ}_{1 + 2} ( {Δ}_{k}^{time} ( {x}_{c} ) , {Δ}_{k}^{time} ( {\hat{x}}_{c} ) )$$

In Equation 3, x_{c} represents the second sequence of reference speech features 312b and \hat{x}_{c} represents the predicted output sequence of speech features 184. Thus, the loss module 320 determines the total speech reconstruction loss 326 according to:

$${ℒ}_{R e c o n} ( {x}_{c} , {\hat{x}}_{c} ) = {ℒ}_{s} ( {x}_{c} , {\hat{x}}_{c} ) + {ℒ}_{f} ( {x}_{c} , {\hat{x}}_{c} ) + {ℒ}_{t} ( {x}_{c} , {\hat{x}}_{c} ) \qquad ( 4 )$$

As such, the training process 300 trains the spoken language model 120 (FIG. 1) based on the first cross-entropy loss terms 322, the second cross-entropy loss terms 324, and the reconstruction losses 326 determined for the plurality of training utterances 310. Here, training the spoken language model 120 may include updating parameters of the spoken language model 120.

In some implementations, the loss module 320 determines first and second reconstruction loss terms 326a, 326b between the corresponding sequence of predicted speech features 184 and the corresponding second sequence of reference speech features 312b. Thereafter, the loss module 320 determines feature deltas 327 between the corresponding sequence of predicted speech features 184 and the corresponding second sequence of reference speech features 312b and determines time-deltas 328 between the corresponding sequence of predicted speech features 184 and the corresponding second sequence of reference speech features 312b. To that end, the loss module 320 determines the speech reconstruction loss 326 based on a function of the first and second reconstruction loss terms 326a, 326b, the feature deltas, 327, and the time deltas 328. The loss module 320 may determine the function according to:

$${Δ}_{k}^{time} ( z ) = {z}_{[ 1 : T - k , : ]} - {z}_{[ k : T , : ]} , \qquad ( 5 )$$

$${Δ}_{k}^{feat} ( z ) = {z}_{[ 1 : F - k , : ]} - {z}_{[ : , k : F ] ,}$$

$${ℒ}_{1 + 2} ( z , {z}^{′} ) = ‖z - {z}^{′} {‖}_{1} + ‖z - {z}^{′} {‖}_{\frac{2}{2}}$$

Advantageously, the training process 300 trains the spoken language model 120 using a speech recognition loss (e.g., first cross-entropy loss term 322), a transcript continuation loss (e.g., second cross-entropy loss term 324), and a conditional speech synthesis loss (e.g., speech reconstruction loss 326). The speech recognition loss teaches the spoken language model 120 to transcribe speech audio into text. The transcript continuation loss teaches the spoken language model 120 to reuse, maintain, and leverage the ability of the pre-trained language model decoder to generate natural text as learned during pre-training. Moreover, the conditional speech synthesis loss teaches the spoken language model 120 to reuse the autoregressive generation ability of the language model decoder 160 and direct it toward spectrogram reconstruction. In this way, the spoken language model 120 uses the language model decoder 160 to synthesize arbitrary textual continuations at inference time which includes words not found during training. Notably, during inference, a sequence of speech features 102 (FIG. 1) characterizing only the spoken prompt 106 is received and processed by the spoken language model 120 to generate each of the transcription 162 of the spoken prompt 106 spoken by the user, the text representation 164 of the continuation 108 to the spoken prompt 106, and the sequence of speech features 182 (e.g., mel-frequency spectrograms) characterizing the continuation 108.

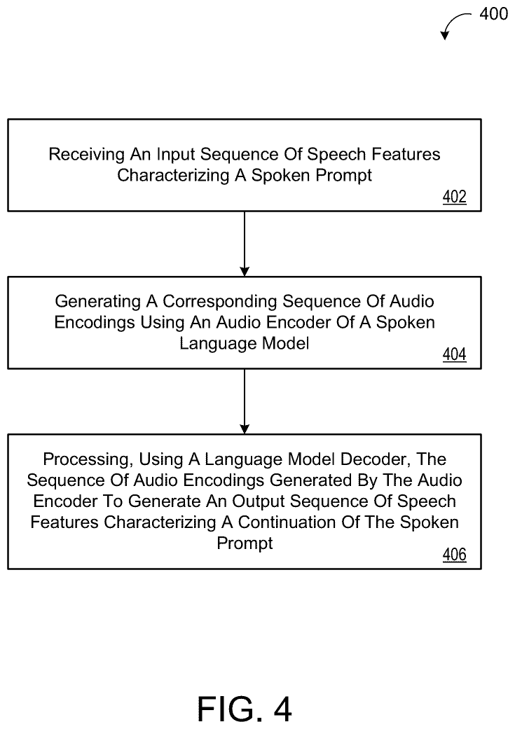

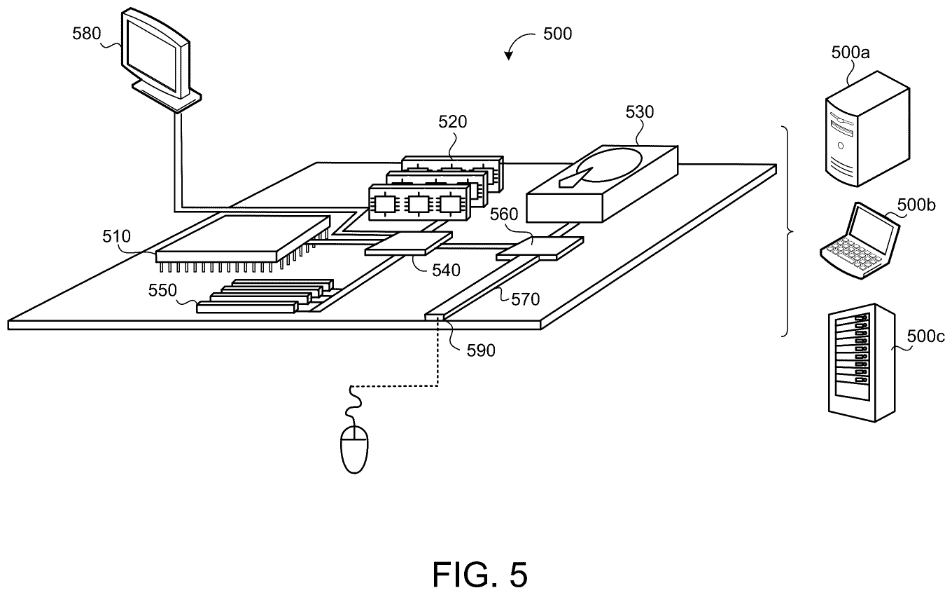

FIG. 4 includes a flowchart of an example arrangement of operations for a computer-implemented 400 of executing a spoken language model. The method 400 may execute on data processing hardware 510 (FIG. 5) using instructions stored on memory hardware 520 (FIG. 5) that may reside on the user device 110 and/or the remote system 140 of FIG. 1 each corresponding to a computing device 500 (FIG. 5).

At operation 402, the method 400 includes receiving an input sequence of speech features 102 characterizing a spoken prompt 106. At operation 404, the method 400 includes generating, using an audio encoder 150 of a spoken language model 120, a corresponding sequence of audio encodings 152. At operation 406, without applying any intermediary cross-attention to the sequence of audio encodings 152 between the audio encoder 150 and a language model decoder 160 of the spoken language model 120, the method 400 includes processing, using the language model decoder 160, the sequence of audio encodings 152 generated by the audio encoder 150 to generate an output sequence of speech features 182 characterizing a continuation 108 of the spoken prompt 106.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure

can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A spoken language model comprising:
an audio encoder configured to:
receive, as input, a sequence of speech features characterizing a spoken prompt; and
generate, as output, a corresponding sequence of audio encodings; and
a language model decoder configured to:
receive, as input, the sequence of audio encodings output from the audio encoder without any intermediary cross-attention applied to the sequence of audio encodings between the audio encoder and the language model decoder; and
generate, as output, an output sequence of speech features characterizing a continuation of the spoken prompt.

2. The spoken language model of claim 1, wherein the language model decoder is further configured to generate, as output, a transcription of the spoken prompt and a text representation of the continuation.

3. The spoken language model of claim 2, wherein the language model decoder generates the output sequence of speech features autoregressively based on a concatenation of the transcription of the spoken prompt and the text representation of the continuation.

4. The spoken language model of claim 3, wherein the language model decoder generates the output sequence of speech features autoregressively based on generating each speech feature in the output sequence of speech features at each corresponding time step subsequent to an initial time step by:
obtaining the speech feature generated by the language model decoder at an immediately previous time step;
processing, by an input acoustic projection layer, the speech feature generated by the language model decoder at the immediately previous time step to generate a corresponding previous input speech embedding;
processing, using the language model decoder, the sequence of audio encodings, the concatenation of the transcription of the spoken prompt and the text representation of the continuation, and the corresponding previous input speech embedding to generate a corresponding output speech embedding at the corresponding time step; and
processing, by an output acoustic projection layer, the corresponding output speech embedding to generate the speech feature at the corresponding time step.

5. The spoken language model of claim 1, further comprising an output acoustic projection layer, wherein:
the output sequence of speech features comprises a sequence of output speech embeddings in a domain of the language model decoder; and
the output acoustic projection layer is configured to project the sequence of output speech embeddings into an output sequence of mel-spectrogram frames characterizing the continuation of the spoken prompt.

6. The spoken language model of claim 5, wherein:
a synthesizer is configured to convert the output sequence of mel-spectrogram frames into synthesized speech that conveys the continuation of the spoken prompt; and
an audible output device is configured to audibly output the synthesized speech conveying the continuation of the spoken prompt.

7. The spoken language model of claim 1, wherein the sequence of speech features comprises an input sequence of mel-frequency spectrogram frames.

8. The spoken language model of claim 1, wherein the audio encoder comprises a plurality of multi-head attention layers.

9. The spoken language model of claim 8, wherein each multi-head attention layer comprises a conformer layer comprising:
a first feed-forward layer;
a self-attention layer;
a convolution layer; and
a second feed-forward layer.

10. The spoken language model of claim 1, wherein the language model decoder comprises a prefix-language model architecture.

11. The spoken language model of claim 1, wherein a training process jointly trains the audio encoder and the language model decoder by:
obtaining a plurality of training utterances, each respective training utterance comprising:
audio data segmented into:
a first sequence of reference speech features characterizing a corresponding prompt segment of the respective training utterance; and
a second sequence of reference speech features characterizing a corresponding continuation segment of the respective training utterance; and
a ground-truth transcript of the audio data, the ground-truth transcript segmented into:
a first text segment representing a transcription of the corresponding prompt segment of the respective training utterance; and
a second text segment representing a transcription of the corresponding continuation segment of the respective training utterance;
for each respective training utterance:
processing, by the audio encoder, the first sequence of reference speech features to generate a corresponding sequence of training audio encodings;
processing, by the language model decoder:
the corresponding sequence of training audio encodings to generate a corresponding predicted sequence of speech recognition results; and
the first text segment to generate a corresponding predicted text segment;
determining a first cross-entropy loss term based on the corresponding predicted sequence of speech recognition results and the first text segment representing the transcription of the corresponding prompt segment of the respective training utterance; and
determining a second cross-entropy loss term based on the corresponding predicted text segment and the second text segment representing the transcription of the corresponding continuation segment of the respective training utterance; and
training the spoken language model based on the first cross-entropy loss terms and the second cross-entropy loss terms determined for the plurality of training utterances.

12. The spoken language model of claim 11, wherein the training process further jointly trains the audio encoder and the language model decoder by:
for each respective training utterance:
processing, by an input acoustic projection layer, the second sequence of reference speech features to generate a corresponding sequence of reference speech embeddings;
processing, by the language model decoder, the corresponding sequence of reference speech embeddings to generate a corresponding sequence of predicted speech embeddings;
processing, by an output acoustic projection layer, the corresponding sequence of predicted speech embeddings to generate a corresponding sequence of predicted speech features; and
determining a speech reconstruction loss based on the corresponding sequence of predicted speech features and the corresponding second sequence of reference speech features characterizing the continuation segment of the training utterance; and
training the spoken language model based on the first cross-entropy loss terms, the second cross-entropy loss terms, and the reconstruction losses determined for the plurality of training utterances.

13. The spoken language model of claim 12, wherein determining the reconstruction loss comprises:
determining first and second reconstruction loss terms between the corresponding sequence of predicted speech features and the corresponding second sequence of reference speech features;
determining feature-deltas between the corresponding sequence of predicted speech features and the corresponding second sequence of reference speech features;
determining time-deltas between the corresponding sequence of predicted speech features and the corresponding second sequence of reference speech features; and
determining the speech reconstruction loss based on a function of the first and second reconstruction loss terms, the feature-deltas, and the time deltas.

14. The spoken language model of claim 11, wherein, prior to jointly training the audio encoder and the language model decoder, the audio encoder is initialized with a pre-trained audio encoder and the language model decoder is initialized with a pre-trained language model decoder.

15. A computer-implemented method executed on data processing hardware that causes the data processing hardware to perform operations comprising:
receiving an input sequence of speech features characterizing a spoken prompt;
generating, using an audio encoder of a spoken language model, a corresponding sequence of audio encodings; and
without applying any intermediary cross-attention to the sequence of audio encodings between the audio encoder and a language model decoder of the spoken language model, processing, using the language model decoder, the sequence of audio encodings generated by the audio encoder to generate an output sequence of speech features characterizing a continuation of the spoken prompt.

16. The computer-implemented method of claim 15, wherein the operations further comprise generating, using the language model decoder, a transcription of the spoken prompt and a text representation of the continuation.

17. The computer-implemented method of claim 16, wherein the language model decoder generates the output sequence of speech features autoregressively based on a concatenation of the transcription of the spoken prompt and the text representation of the continuation.

18. The computer-implemented method of claim 17, wherein the language model decoder generates the output sequence of speech features autoregressively based on generating each speech feature in the output sequence of speech features at each corresponding time step subsequent to an initial time step by:
obtaining the speech feature generated by the language model decoder at an immediately previous time step;
processing, by an input acoustic projection layer, the speech feature generated by the language model decoder at the immediately previous time step to generate a corresponding previous input speech embedding;
processing, using the language model decoder, the sequence of audio encodings, the concatenation of the transcription of the spoken prompt and the text representation of the continuation, and the corresponding previous input speech embedding to generate a corresponding output speech embedding at the corresponding time step; and
processing, by an output acoustic projection layer, the corresponding output speech embedding to generate the speech feature at the corresponding time step.

19. The computer-implemented method of claim 15, wherein:
the output sequence of speech features comprises a sequence of output speech embeddings in a domain of the language model decoder; and
wherein the operations further comprise projecting, using an output acoustic projection layer of the spoken language model, the sequence of output speech embedding into an output sequence of mel-spectrogram frames characterizing the continuation of the spoken prompt.

20. The computer-implemented method of claim 19, wherein the operations further comprise:
converting, using a synthesizer, the output sequence of mel-spectrogram frames into synthesized speech that conveys the continuation of the spoken prompt; and
audibly outputting, using an audible output device, the synthesized speech conveying the continuation of the spoken prompt.

21. The computer-implemented method of claim 15, wherein the sequence of speech features comprises an input sequence of mel-frequency spectrogram frames.

22. The computer-implemented method of claim 15, wherein the audio encoder comprises a plurality of multi-head attention layers.

23. The computer-implemented method of claim 22, wherein each multi-head attention layer comprises a conformer layer comprising:
a first feed-forward layer;
a self-attention layer;
a convolution layer; and
a second feed-forward layer.

24. The computer-implemented method of claim 15, wherein the language model decoder comprises a prefix-language model architecture.

25. The computer-implemented method of claim 15, wherein the operations further comprise executing a training process that jointly trains the audio encoder and the language model decoder by:
obtaining a plurality of training utterances, each respective training utterance comprising:
audio data segmented into:
a first sequence of reference speech features characterizing a corresponding prompt segment of the respective training utterance; and
a second sequence of reference speech features characterizing a corresponding continuation segment of the respective training utterance; and
a ground-truth transcript of the audio data, the ground-truth transcript segmented into:
a first text segment representing a transcription of the corresponding prompt segment of the respective training utterance; and
a second text segment representing a transcription of the corresponding continuation segment of the training utterance;
for each respective training utterance:
processing, by the audio encoder, the first sequence of reference speech features to generate a corresponding sequence of training audio encodings;
processing, by the language model decoder:
the corresponding sequence of training audio encodings to generate a corresponding predicted sequence of speech recognition results; and
the first text segment to generate a corresponding predicted text segment;
determining a first cross-entropy loss term based on the corresponding predicted sequence of speech recognition results and the first text segment representing the transcription of the corresponding prompt segment of the respective training utterance; and
determining a second cross-entropy loss term based on the corresponding predicted text segment and the second text segment representing the transcription of the corresponding continuation segment of the respective training utterance; and
training the spoken language model based on the first cross-entropy loss terms and the second cross-entropy loss terms determined for the plurality of training utterances.

26. The computer-implemented method of claim 25, wherein executing the training process further jointly trains the audio encoder and the language model decoder by:
for each respective training utterance:
processing, by an input acoustic projection layer, the second sequence of reference speech features to generate a corresponding sequence of reference speech embeddings;
processing, by the language model decoder, the corresponding sequence of reference speech embeddings to generate a corresponding sequence of predicted speech embeddings;
processing, by an output acoustic projection layer, the corresponding sequence of predicted speech embeddings to generate a corresponding sequence of predicted speech features; and
determining a speech reconstruction loss based on the corresponding sequence of predicted speech features and the corresponding second sequence of reference speech features characterizing the continuation segment of the training utterance; and
training the spoken language model based on the first cross-entropy loss terms, the second cross-entropy loss terms, and the reconstruction losses determined for the plurality of training utterances.

27. The computer-implemented method of claim 26, wherein determining the reconstruction loss comprises:
determining first and second reconstruction loss terms between the corresponding sequence of predicted speech features and the corresponding second sequence of reference speech features;
determining feature-deltas between the corresponding sequence of predicted speech features and the corresponding second sequence of reference speech features;
determining time-deltas between the corresponding sequence of predicted speech features and the corresponding second sequence of reference speech features; and
determining the speech reconstruction loss based on a function of the first and second reconstruction loss terms, the feature-deltas, and the time deltas.

28. The computer-implemented method of claim 25, wherein, prior to jointly training the audio encoder and the language model decoder, the operation further comprise:
initializing the audio encoder with a pre-trained audio encoder; and
initializing the language model decoder with a pre-trained language model decoder.
